(19) United States
(12) Patent Application Publication
(10) Pub. No.: US 2002/0142070 A1
(43) Pub. Date: Oct. 3, 2002

(54) Frozen food product with topping

(76) Inventors: Arti Bedi, Plymouth, MN (US); Elizabeth F. Burgess, River Falls, WI (US)

Correspondence Address: KAGAN BINDER, PLLC, Intellectual Property Attorneys, Maple Island Building, Suite 200, 221 Main Street North, Stillwater, MN, 55082, US

(21) Appl. No.: 10/103,162

(22) Filed: Mar. 20, 2002

Related U.S. Application Data
(63) Continuation of application No. 09/648,702, filed on Aug. 25, 2000.

(51) Int. Cl. A21D 13/00

(52) U.S. Cl. 426/76

(57) ABSTRACT

Described food compositions including a topping composition, as well as packaged food products containing a topping composition and a food product. Preferred topping compositions have reduced freezing points and are fluid at freezing and sub-freezing temperatures.

### FIELD OF THE INVENTION

The invention relates to topping compositions and to packaged food products containing a frozen food product and a topping composition.

### BACKGROUND

A variety of dough products, batter products, and similar food products, are desirable to consumers, including dough products with toppings or fillings such as donuts, strudels, pastries, etc. While consumers desire food with appealing taste and texture, they also desire food products that are simple and easy to prepare and consume, and food products sold in combination with toppings such as frostings, syrups, or sauces, are very popular these days. With respect to ease of preparation, consumers enjoy food products that can be stored for long periods of time, e.g., by refrigeration or freezing, and that can be quickly reheated and consumed. To this end, food products that are sold and stored at a reduced temperature and that can be warmed or heated in an oven or toaster, can be highly desirable.

Food products such as dough and batter products can include optional fillings or toppings, for example a sweetened icing topping. Toppings are often applied to a food product after warming the food product, e.g., in a toaster, microwave, or conventional oven. For instance, donuts, strudels, or breakfast pastries often include a sweet topping or icing that is applied after warming the food product. The icing can for convenience be individually packaged along with the food product, and stored at low-temperature (e.g., 0 to 32° F.). While the donut, strudel, or pastry is being warmed, the icing remains close to its storage temperature, but is desirably ready for consumption as soon as the food product is suitably warmed. As such, preferred icings, in addition to having desirable flavor and texture, etc., should be capable of being applied to a food product shortly after removal from a low temperature environment, but should also not be too runny at room temperature.

There is a need for flavorful food products, including toppings, that can be stored for lengthy periods, and are convenient to prepare and eat.

### SUMMARY OF THE INVENTION

The invention relates to packaged food products that include a frozen food product and a topping, wherein the packaged food product can be stored at reduced temperatures, and wherein the frozen food product (also referred to herein as the “food product”) optionally after being warmed or thawed, can be dipped in the topping to apply the topping to the food product soon after the topping is removed from reduced-temperature storage.

Preferred food products can comprise a batter product or dough product. The dough or batter product can preferably by partially-cooked or fully-cooked, and frozen; cooking can be accomplished, e.g., by baking, boiling, frying, deep frying, using a griddle, or any other method. A preferred dough or batter product can be any of a very wide variety of such products that can be consumed with a topping. The dough or batter product can be prepared from standard dough or batter ingredients, including combinations of flour, water, optional yeast, shortening, etc. These ingredients can be processed by combining and mixing some or all of them into a dough or batter composition, as is known, and processing into a cooked dough or batter product. For dough products in particular, a dough composition can be processed by sheeting, cutting, and forming a dough composition into a desired product shape or configuration (optionally including a filling). The cut and shaped configuration can be at least partially cooked and then frozen and packaged for sale to consumers.

The frozen food product can be consumed either while it is still cold or frozen, or after cooking, partially cooking, thawing, or warming, e.g., in an oven (conventional or microwave), a toaster, a toaster oven, or the like. Preferred food products can be of a size and shape that will fit into a toaster, e.g., a donut or donut-like product, for example, in the shape of donut sticks, e.g., multiple donut sticks connected by a line of weakening. The food product and the topping can be sold together, in combination, as a packaged, frozen or refrigerated food product.

Preferred toppings have a sufficiently low freezing point such that the topping can be easily applied to the dough product soon after removal from reduced-temperature storage in a refrigerator or freezer. Specifically, if a quantity of the topping, taking into consideration the amount and its packaging, is exposed to room temperature for the time that it takes to warm the food product, the topping will be sufficiently fluid that the food product (whether frozen, thawed, or warmed) can be dipped into the topping to apply to the topping to the food product. For example, an icing may have reduced melting and freezing temperatures such that the icing can be preferably applied to a food product by dipping the food product into a small container of the icing. While other modes of application are also possible, application by dipping means that a consumer will be able to use their fingers to bring the food product into contact with the topping to allow or cause the topping to adhere to the food product and the food product and topping can be eaten together. Dipping can include simply bringing a food product into contact with a fluid topping, which preferably means that the topping is sufficiently fluid to allow a food product to be submerged or immersed in the topping. Depending on the surface composition of the food product, the topping may adhere to and remain on the food product for consumption. To facilitate application of the topping to the food product, and possibly to increase adhesion of the topping to the food product, it is also contemplated that the food product can be used by the consumer to scoop the topping from the container.

Toppings with preferred fluidity can have a viscosity that allows application of the topping to a food product by dipping. Exemplary viscosities can be in the range from about 500,000 to about 100,000,000 centipoise (cps) at a temperature of 0° F., e.g., from about 1,000,000 to about 10,000,000, preferably from about 1,000,000 to about 3,000,000, or about 5,000,000, measured using a Rheometrics Differential Stress Rheometer (DSR). Preferred toppings can also have a melting point in the range from about minus 34 to minus 25° C. Melting point can be measured by known methods such as differential scanning calorimetry (DSC).

The invention can be applied to toppings formulated for any variety of uses, and can be of any flavor or for use with any type of food product, particularly but not necessarily with dough products and batter product. Preferred toppings can be icings or frostings, dairy-type toppings, cheeses, syrups, dressings, spicy or hot toppings, fruit or vegetable sauces, etc. In other words, the inventive formulations can be used to prepare a variety of toppings having reduced freezing and/or melting points, and preferably being fluid at reduced temperatures such as 32° F. or 0° F.

An aspect of the invention relates to a packaged food product comprising a frozen food product such as a batter or dough product, and a packaged topping. The topping, if exposed to room temperature for a time taken to warm the food product, is sufficiently fluid that the topping can be applied to the food product by dipping the food product in the topping composition. The frozen food product may be partially or fully cooked.

Another aspect of the invention relates to a method of preparing a food product. The method comprises: providing a packaged food product comprising a frozen food product and a topping which if exposed to room temperature for a time taken to warm the frozen food product is sufficiently fluid that the topping can be applied to the food product by dipping the food product in the topping; warming the frozen food product; and applying the topping to the food product, preferably by dipping the food product in the topping.

Yet another aspect of the invention relates to a food topping comprising fat, flavoring, water, high-fructose corn sweetener, and water-activity reducing agent. The topping is sufficiently fluid at OF that the topping can be applied to a food product by dipping the food product in the topping.

### BRIEF DESCRIPTION OF THE DRAWINGS

FIG. 1 is a view of an embodiment of a food product as described herein.

FIG. 2 is a view of an embodiment of a filled food product as described herein.

### DETAILED DESCRIPTION

Packaged Food Product

The invention contemplates packaged food products that include a food product and a topping. The food product preferably comprises a dough product, a batter product, or the like, preferably cooked or at least partially cooked, and frozen. The food product and the topping can be sold together, in combination, as a single packaged, frozen or refrigerated food product (the term “packaged food product” will be used herein to refer to the combination of the “frozen food product”—also referred to as the “food product”—and the topping, combined in a packaged form, which package may include single or multiple servings of the food product and/or topping). Examples of preferred embodiments of packaged food products include breakfast foods such as pastries, strudels, donuts, or donut-sticks sold in a packaged combination with an icing topping; a batter product such as a waffle or pancake product sold in combination with a syrup topping, or a crepe product in combination with a fruit or other topping; a biscuit product with a desired topping; cinnamon-flavored rolls in combination with an icing; bagels or bagel-sticks in combination with a dairy topping such as a cream cheese topping; a soft pretzel in combination with a cheese or cheese-flavored topping; and bread sticks in combination with a pizza (e.g., tomato) sauce.

The topping can be included in the packaged food product in multiple packages suitable for individual servings, having a size and configuration to allow the food product to be dipped in the container. The food product can be sold in a reduced-temperature, e.g., frozen state, and may be consumed as such, or may be thawed or maintained at a refrigerated temperature, and is preferably warmed prior to consumption. The topping of the packaged food product can be subjected to a wide range of temperature conditions, from frozen to thawed and refrigerated temperatures, to room temperature (e.g., 25° C.), and ultimately, if contacted with a warmed food product, to the temperature of the warmed food product.

Food Product

The food product of the packaged food product can be any food product that can usefully or desirably be frozen (e.g., at a temperature below 32° F.) and eaten (in a frozen, thawed, or warmed state) with a topping. The food product may be fried, baked, or otherwise fully or partially cooked. Preferred food products include dough products, batter products, and similar types of food products. Examples include a donut or donut-stick; a cake or cookie product; roll; pastry; strudel; croissant; bun; biscuit; crust; breakfast products such as a waffle, pancake, crepe, or the like; bagel or bagel stick; soft pretzel; bread such as French bread, rye bread, or bread stick; sticky bun; and other similar or different food products. In some preferred embodiments, dough products are sweetened donut-like products, preferably partially or fully cooked by frying, and most preferably shaped in the form of multi-part sticks or stick-like dough products that are fixed to one another, but that can be easily pulled apart and separately dipped in a topping. The dough product may optionally be filled, e.g., with sweet or savory filling. Alternatively, the food product could be an entirely different type of food product, for use with a topping, such as a vegetable, potato, or egg-based or containing product, suitable for use with a topping.

Such food products, including dough products, batter products, and others, can be produced by known methods using known ingredients, any of which can be useful for producing a food product for use according to the invention. And while the following disclosure relates particularly to exemplary dough compositions, this does not imply any limitation on the food product used according to the invention; the invention contemplates the use of any food product in combination with a topping described below, e.g., in a packaged food composition.

Dough Composition

A dough product, for example, can be prepared by cooking a dough composition, which can be prepared from ingredients generally known in the dough composition or bread-making art, typically minimally including flour, a liquid component, and a leavening agent, and optionally including such additional ingredients as fat components, salt, sweeteners, dairy products, egg products, processing aids, emulsifiers, particulates, added flavorings, and the like.

The flour component can be any suitable flour or combination of flours, including glutenous and nonglutenous flours, and combinations thereof. The flour or flours can be whole grain flour, flour with the bran and/or germ removed, or combinations thereof.

Typically, a dough composition can include between about 30% and about 70% by weight flour, e.g., from about 45% to about 60% percent by weight flour, such as from about 50 to 55 weight percent flour.

The dough composition can also include one or more liquid components. Examples of liquid components include water, milk, eggs, and oil, or any combination of these. Preferably, the liquid component includes water, e.g., in an amount in the range from about 15 to 35 weight percent, although amounts outside of this range may also be useful. Water may be added during processing in the form of ice, to control the dough temperature in-process; the amount of any such water used is included in the amount of liquid components. The amount of liquid components included in any particular dough composition can depend on a variety of factors including the desired moisture content of the dough composition. Typically, liquids can be present in a dough composition in an amount between about 15% by weight and about 35% by weight, e.g., between about 20% by weight and about 30% by weight.

The dough composition can optionally include an egg product, e.g., for flavoring. Examples of egg products include fresh eggs, egg substitutes, dried egg products, frozen egg products, etc. The amount of egg products, if used, can be between about 0.1 percent by weight and about 35 percent by weight. The egg products may be in a dried form or a liquid form. If a liquid form of egg product is used, the amount of liquid component is adjusted to take into account the moisture content resulting from the liquid egg product.

The dough composition can optionally include dairy products such as milk, buttermilk, or other milk products, in either dried or liquid forms. Alternatively, milk substitutes such as soy milk may be used. If used, dairy products can be included as up to about 25 percent by weight of the dough composition, e.g., between about 1 percent and about 10 percent of the dough composition. If a dried dairy product is used, it is not considered to be part of the liquid component identified above; if a liquid form of a dairy product is used, the amount of other liquid components, if any, can be adjusted accordingly.

The dough composition can optionally include fat ingredients such as oils and shortenings. Examples of suitable oils include soybean oil, corn oil, canola oil, sunflower oil, and other vegetable oils. Examples of suitable shortenings include animal fats and hydrogenated vegetable oils.

If included, fat is typically used in an amount less than about 20 percent by weight, often less than 10 percent by weight of the dough composition. If liquid oils are used as a fat, the amount of other liquid components can be adjusted accordingly. One of ordinary skill will recognize that the chosen amounts and types of fats included can be adjusted depending on the desired texture of the dough product.

The dough composition can optionally include one or more sweeteners, either natural or artificial, liquid or dry. If liquid sweeteners are used, the amount of other liquid components can be adjusted accordingly. Examples of suitable dry sweeteners include lactose, sucrose, fructose, dextrose, maltose, corresponding sugar alcohols, and mixtures thereof. Examples of suitable liquid sweeteners include high fructose corn syrup, malt, and hydrolyzed corn syrup. Often, dough compositions include between about 2% by weight and about 15% by weight, e.g., from about 5% by weight to about 10% by weight sweetener.

The dough composition can further include additional flavorings, for example, salt, such as sodium chloride and/or potassium chloride; whey; malt; yeast extract; inactivated yeast; spices; vanilla; etc.; as is known in the dough product arts. The additional flavoring can typically be included in an amount in the range from about 0.1 percent to about 10 percent of the dough composition, e.g., from about 0.2 percent to about 5 percent of the dough composition.

The dough composition can optionally include particulates such as raisins, currants, fruit pieces, nuts, seeds, vegetable pieces, and the like, in suitable amounts.

As is known, dough compositions can also optionally include other additives, colorings, and processing aids such as emulsifiers, strengtheners (e.g., ascorbic acid), preservatives, and conditioners. Suitable emulsifiers include lecithin, mono- and diglycerides, polyglycerol esters, and the like, e.g., diacetylated tartaric esters of monoglyceride (DATEM) and sodium stearoyl-2-lactylate (SSL).

Conditioners, as are known in the dough products art, can be used to make the dough composition tougher, drier, and/or easier to manipulate. Examples of suitable conditioners can include azodicarbonamide, potassium sulfate, L-cysteine, sodium bisulfate and the like. If used, azodicarbonamide is preferably not present in an amount more than 45 parts per million.

Filling

In some embodiments, dough products can include a filling. The types of fillings suitable for the dough products herein include fillings described in U.S. Pat. Nos. 4,612,198 and 4,623,542, incorporated herein by reference.

The filling can have a uniform consistency or a chunky consistency. If the filling includes chunks, the chunks are preferably small enough that they do not deform the food product during processing. In preferred embodiments, the filling can be a viscous liquid, suspension, or a flowable mixture of particulates and/or liquid. The filling preferably is highly viscous such that it will not flow immediately through any imperfection in the dough composition or out of the seams.

The filling or ingredients of the filling can include raw or cooked food products or food ingredients, any of which can be previously frozen and subsequently thawed and/or cooked. The filling can be made from any type or types of food ingredients, including meat ingredients, vegetable ingredients, dairy ingredients, fruit ingredients, spices, flavorings, fats and the like. Suitable fillings include cream cheese, cinnamon, fruit fillings, peanut butter, and the like. The filling can further include property modifiers, for example, fat components, starches, stabilizers, preservatives, etc.

Preparation of a Dough Composition

To produce a dough product, a dough composition (raw) is first produced. This can be accomplished according to methods and steps that are known in the dough and dough product arts, for example according to one or more of the following steps, not to the exclusion of other steps, and not necessarily in the recited order.

Yeast

Yeast can be included in the dough composition as a pre-hydrated yeast, or from a dried yeast that is re-hydrated. Either type may be acceptable, and either may be chosen for reasons of convenience or cost.

To prepare a dried yeast leavening agent for use, an active yeast composition can be hydrated to form a yeast slurry that can be incorporated into the flour. This will be known and understood by a skilled artisan. In a yeast slurry, the yeast is typically substantially dispersed without any undesirable lumps. The yeast slurry can be mixed, tumbled, or agitated in a suitable manner to prevent the yeast from settling to the bottom.

Mixing

Generally, the flour and any other dry ingredients can be combined with the fat component, if used, and then combined with a yeast slurry (if a dry yeast is used) or with a pre-hydrated yeast. All ingredients are generally mixed together, using any of a variety of methods and/or addition orders as are known in the dough-making art, to form a raw dough composition.

Mixing may be performed in commercially available and well-known equipment, for example a horizontal bar mixer with a cooling jacket (e.g., a 2500 lb. horizontal bar mixer from Oshikiri in Japan). The dough composition is generally mixed between about 5 minutes and about 45 minutes, until a proper consistency is achieved. The target temperature for the resulting dough composition is generally between about 50° F. and about 80° F. (as described, this can be controlled at least in part by the use of ice). A farinograph and extensigraph can optionally be used to verify the flour/water ratio and dough composition development, as well as the physical and mechanical properties of the dough composition generally.

Processing

Once the dough composition has been prepared, it can be further processed according to known methods of forming a dough composition into a desired size and shape, and cooking. A variety of techniques can be used to do so, as are known. For example, processing of the dough composition can include one or more of sheeting, extruding, and the like; cutting to a desired size and shape; folding; filling; and cooking.

Sheeting

In some embodiments, the dough composition can be sheeted to transform a mass of a dough composition, after mixing, into a relatively thin, substantially flat, continuous web or film that can be further processed by cutting and shaping, optionally filling and folding, to produce a desired dough product. As an example, a dough composition can be pre-sheeted to initiate the sheeting process to form a continuous sheet of dough composition. The actual thickness of the dough composition sheet at this point is not critical as long as the thickness is consistent as the dough composition enters the sheeter.

The dough composition, in the sheeting apparatus, is compressed to form a sheeted dough composition of a desired thickness. Sheeting generally involves rolling the pre-sheeted dough composition through at least one set of rollers. The use of more than one set of rollers can be preferred, for gradually increasing the size (area) of the dough composition sheet and decreasing the thickness.

The sheeting steps can optionally be interspersed with other processing steps, such as enrobing steps and/or lapping steps. Enrobing is generally performed in order to add particulates or fat to the dough composition. In enrobing, particulates are added to the surface and then a portion of the dough composition sheet is folded over the particulates and rolled.

Lapping steps involve changing the direction in which the dough composition is worked. Lapping in these doughs reorients the polymers, reducing dough composition snapback. Lapping steps may also be used for addition of plasticizers such as shortening.

The presheeter, the lappers, and rollers of the sheeter may be coated with release agents to cause release of the dough composition without deforming. Release agents can include, for example, flours, starches, and the like. Preferably, a light, even, and consistent coating of release agent can be applied to rollers or lappers.

After removal from the rollers, a dough composition sheet may be dedusted to remove any excess release agents. Dedusting may be performed by brushes designed to remove excess release agents from the surface of the dough composition sheets.

Assembly

The sheeted dough composition can be assembled into any of a variety of shapes and products, as desired. As an example, the sheeted dough product can be cut to size, as desired, and optionally filled. Methods and equipment for shaping, sizing, or otherwise cutting sheeted dough compositions are well known.

Any shape dough product can be prepared and used in combination with a topping as described below. The size and shape of the product may depend on the type of dough product being prepared, as well as other factors such as the dough composition, e.g., whether it is light and/or sweet like a donut or heavy like a pretzel or bagel, whether or not it is intended to be heated (e.g., in a toaster), etc.

Many dough products are preferably suitably sized to fit into a standard pop-up toaster. The length of such a dough product can be between about 3.5 inches and about 5.0 inches, preferably between about 3.8 inches and about 4.5 inches, and more preferably between about 3.9 inches and 4.2 inches; the width of the dough product can be between about 2.0 inches and 4.0 inches, preferably between about 2.5 inches and 3.5 inches and more preferably between about 2.8 inches and 3.2 inches; and the thickness of the dough product can preferably be between about 0.27 inches and about 0.59 inches, more preferably between about 0.35 inches and about 0.36 inches.

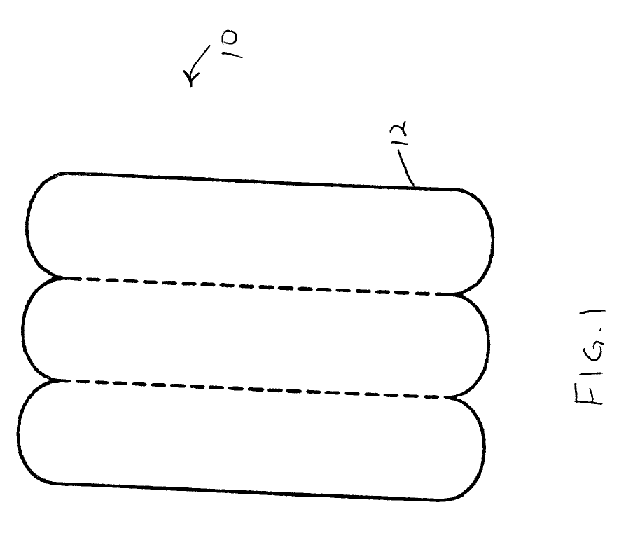

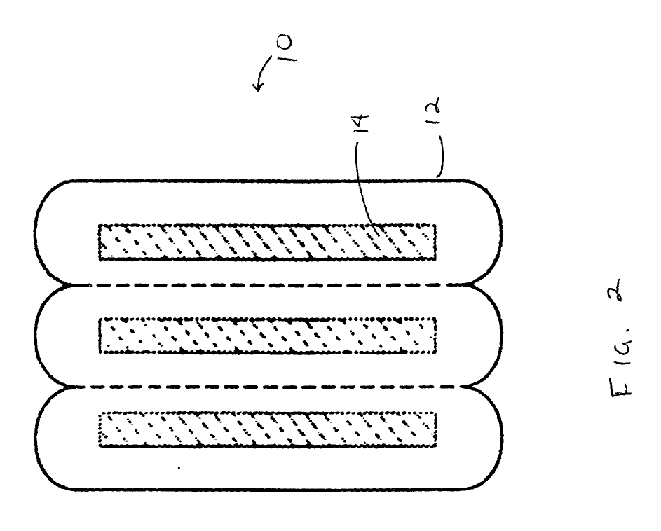

In one preferred embodiment of the invention, the dough product can be cut into the form of donut sticks such as the perforated donut sticks illustrated in FIG. 1. FIG. 1 shows dough product 10, which can be formed as two or more (e.g., three in the FIG. ) elongated donut sticks 12, optionally having rounded ends, connected along their length by a line of weakening, e.g., perforations, and being of a size that can be inserted into a toaster for warming. These can be formed by cutting the sheeted dough composition to size, optionally filling, and perforating. If filling is to be included, as indicated in FIG. 2 as filling 14 (shaded area), sheeting can be followed by a combination of steps including cutting, application of filling, folding, and crimping.

Methods for filling a dough product are well known, and include methods wherein two sheets (a top and a bottom) are separately produced, a filling composition is applied to the bottom, and the top is applied thereover. By another method, a single sheet is produced of double size, a filling is applied to a portion or portions of one side, and the other side is folded thereover. After the top and bottom sheets are placed or folded together, the combined materials can be crimped and cut to form a filled (raw) dough product. The adhesion between top and bottom sheets can be improved by providing water at the seams between the sheets prior to crimping and cutting. The sheets may be side crimped, end crimped, end cut, and/or side cut to form the ends and sides. In one preferred embodiment of the invention, as illustrated in FIG. 1, the process also includes perforation lines. Perforations or other methods of providing lines of weakening to the food product (if desired) can be made in any conventional or developed manner.

Such methods of shaping and sizing a dough product, including steps of sheeting, cutting, folding, perforating, crimping, and otherwise assembling, are well known, and are described, for example, in Assignee's copending U.S. patent application Ser. No. 09/432,446, filed Nov. 3, 1999, and incorporated herein by reference.

Proofing

The dough composition can be proofed, generally after sheeting or otherwise forming and assembling the dough composition into a desired size and shape. Proofing can be accomplished by providing conditions under which fermentation will occur. Proofing a yeast-leavened dough composition results in desired organoleptic properties, for example smell and flavor, after baking. During proofing, the dough composition expands in volume, i.e., the dough composition becomes less dense, due to fermentation of sugars by the yeast to produce gaseous carbon dioxide. Other substances produced during fermentation modify the elasticity, stickiness, and the flow properties of the dough composition.

The proofer generally includes a warming unit that is enclosed with humidification and air flow. Proofing can be performed in a variety of proofing units. Suitable proofing units are supplied, for example, by Frigoscandia Equipment, Redmond, Wash., Northfield Freezing, Northfield, Minn., and Triphase, West Yorkshire, U.K.

While timing and conditions outside of the following ranged can also be useful, proofing can typically be performed at a temperature between about 80° F. and about 115° F., preferably the proofing is performed between about 85° F. and about 110° F., and more preferably between about 90° F. and about 105° F. Proofing can be performed at a relative humidity between about 40% and 95%, preferably between about 45% and about 85% and more preferably between about 50% and about 60%. Proofing is generally performed for between about 20 minutes to about 45 minutes, preferably between about 25 minutes to about 40 minutes and more preferably for between about 28 minutes and about 38 minutes.

Cooking

A dough composition of the invention, for use with the topping described below, can be partially or fully cooked by any suitable method, e.g., fried, baked, boiled, etc.

One method for cooking a preferred donut-like dough product can be frying, which provides desired texture and flavor properties. The exact conditions, such as temperature and timing, chosen for frying a dough composition can depend on factors such as the desired flavor and texture of the dough product (e.g., as they relate to fat content, color, etc.), the size of the cooked dough product relative to the size of the raw dough product (because frying can tend to increase the volume of the dough product), as well as the exact dough formulation. Exemplary conditions for frying a dough product include frying in oil, e.g., for about 20 seconds to 20 minutes at 300 to 500° F., preferably for about 30 seconds to 2 minutes at 345 to 390° F.

Final Processing

Following cooking, the dough product can be further processed as desired, preferably by packaging and freezing the dough product for sale to consumers, especially in combination with a topping. The dough products are generally completely cooked and refrigerated or frozen for storage and distribution; they may be shelf-stable for at least a limited time, but preferably are maintained in a refrigerated or frozen state. The dough products may be ready for consumption with a topping in their frozen state, or upon thawing (thaw and eat), or may be warmed or heated by any of a variety of methods prior to consumption. The dough products can be advantageously made to fit into a standard pop-up toaster. In this case, the dough products can be sufficiently thin to not only fit in a toaster but also to be reheated in a toaster, i.e. all of the product including the filling, if present, can attain a desirable temperature.

Topping

A topping can be applied to the food product, preferably after the food product is thawed, and most preferably after the food product is warmed. Any type of topping of any flavor may be desirable depending on the flavor and properties of the food product. Desirable flavors might include fruit flavors; icings (e.g., chocolate, vanilla, sugar, or another icing flavor); syrup such as maple or fruit-flavored syrups; a dressing; dairy flavors such as cream, cream cheese, or another cheese flavor; vegetable flavors such as tomato; hot or spicy toppings; or the like, as is appropriate for a specific food product. Icing toppings or syrups can be especially desirable in combination with a dough product that is fried and frozen, such as those generally consumable as breakfast products, including pastries, strudels, donuts or donut-sticks, waffles or pancakes, etc. Other combinations of dough product or batter product and topping include cinnamon-flavored rolls in combination with an icing; bagels or bagel-sticks in combination with a dairy topping such as a cream cheese topping; and bread sticks in combination with a pizza (e.g., tomato) sauce.

In general, toppings include a variety of liquid and/or solid ingredients that provide properties of flavor, consistency, optionally sweetness, etc., which are chosen depending on the type of the topping and the dough product to which it is intended to be applied, e.g., whether it is a cheesy topping (which generally contains cheese or cheese flavoring and fats, and relatively less sweetener), an icing or other sweet topping (which contains sweetener and optionally other flavorings), or a topping of another flavor such as a fruit, vegetable, or spice.

Preferred toppings can be formulated according to the invention to have a freezing point that is sufficiently low that when exposed to room temperature (e.g., 25° C.) for a time taken to warm the food product to an eating temperature, the topping is sufficiently fluid that it can be applied to the food product by dipping the food product in the topping composition. The time taken to warm a food product to an eating temperature will vary depending on factors such as the composition and size of the food product and the method of warming, but should be no longer than about 10 minutes, e.g., less than 5 or 4 minutes. For purposes of this discussion, a food product is considered to be warmed to an eating temperature when the inside of the food product reaches a temperature at which the food product is intended to be consumed, e.g., at least about 50° F., but usually not more than about 160° F. The inside of a food product, e.g., a dough or a batter product, can typically be warmed to such an eating temperature typically within about 5 minutes, e.g., 3 or 4 minutes, if a toaster is used.

Particularly preferred toppings can be fluid at temperatures below freezing, i.e., below 32° F., preferably at 0° F. or lower, such that the topping can be applied to a food product by dipping the food product in the topping. This means that the topping can be applied to the food product by dipping, very soon or immediately after both have been removed from a freezer, even without thawing or warming the food product, before the topping has had any time to thaw or warm up. Stated differently, preferred toppings can have a depressed freezing temperature, or melting temperature, such that the topping remains fluid below about 32 Fahrenheit, and preferably down to at least 0° F., and can be applied to a food product at that temperature by dipping. At the same time the topping will preferably not become unacceptably runny at room temperature. While application by dipping can be preferred, and the toppings of the invention allow such application, the topping may also be applied, even at such reduced temperatures, by methods such as spreading the topping onto a food product or squeezing the topping from an individual package such as an envelope.

A preferred package for a topping can be a package that allows a food product to be dipped in the topping. For example, a topping package can include a surface that is openable to an area of a size that allows dipping of a food product. Preferably, the size of the package and the area for dipping can be related to the size of a breakable portion of the food product, so that when the portion is broken it can be dipped in the package to remove topping. An example is a small cup (e.g., of rigid plastic) which is of a size and which has an open area that allows a breakable portion of a food product (e.g., donut stick as shown in FIG. 1) to be dipped in the topping.

Due to practicality, topping containers such as cups are normally of a size that will not allow the entire contents to substantially warm up, e.g., achieve room temperature, in the time that it takes to warm a food product such as donut sticks. This depends, of course, on the amount of topping included in the cup, as well as the dimensions of the cup. Larger surface area per volume can improve the amount of heat energy that flows into a topping in any given amount of time. Use of the inventive toppings, having reduced freezing points and increased fluidity at reduced temperature, allows the use of containers having larger volume per surface area, because the toppings can be fluid without requiring significant warming from the in-flow of heat energy.

One embodiment of a useful rigid plastic cup can have a volume of about 25 cubic centimeters and dimensions of length in the range from about 2.5 to 3.5 inches, e.g., 3.0 inches; width in the range from about 2.0 to 2.5 inches, e.g., about 2.1 inches; and depth in the range from about 0.3 to 0.5 inches, e.g., about 0.4 inches. Because most dimensions of rigid plastic containers will not provide warming of all of the icing in a container to near room temperature within the time that a frozen food product can be warmed, e.g., in a toaster, it is important that the topping has sufficient fluidity at its storage temperature or slightly above to allow application, especially by dipping, without warming.

Fluidity and melting and freezing properties of a topping composition can be measured by properties including viscosity and melting and freezing points. Preferred toppings can have a viscosity that allows application by dipping at sub-freezing temperatures. Exemplary viscosities can be in the range from about 500,000 to about 10,000,000 (cps), preferably from about 1,000,000 to about 5,000,000, at a temperature below 32° F., e.g., at 0° F. These viscosities, at 0° F., are as measured using a Rheometrics Differential Stress Rheometer (DSR) using a constant stress ramp from 100 pascals (Pa) to 1000 Pa. Exemplary melting points are below about negative 20° C., e.g., about negative 28° C. to about negative 32° C. The melting point of a topping composition can be measured by known methods, such as by differential scanning calorimetry (DSC).

It has been found that proper selection of the amount of high fructose corn sweetener, and inclusion of a water-activity reducing agent, in combination with other ingredients of a topping, can provide a topping having one or more of desirable properties of freezing point reduction and fluidity over a range of reduced temperatures. For example, it has been found that toppings containing ingredients including fat, water, and flavoring, etc., can include high fructose corn sweetener and a water-activity reducing agent in amounts that will depress freezing and melting temperatures, reduce viscosity, and increase fluidity, at sub-freezing temperatures.

Water-Activity Reducing Agent

A water-activity reducing agent may be included in a topping composition, in combination with other ingredients such as high fructose corn syrup, flavoring, and fat, to affect the freezing point and fluidity of the topping. Water-activity reducing agents, or humectants, are ingredients that are well known in the chemical and food-processing arts. According to the invention, the water-activity reducing agent can be any such ingredient that reduces water activity within a topping and thereby is able to reduce the freezing temperature of the topping. Examples of such materials include salts such as GRAS salts, saccharides such as dextrose, and polyols, especially low molecular weight polyols. Most preferably the water-activity reducing agent can reduce water activity, thereby reducing the freezing temperature of the topping, and can also provide a topping with enhanced fluidity. This occurs if the water-activity reducing agent is a fluid such as glycerine. Specific examples of water-activity reducing agents include polyol compounds such as glycerine, mannitol, sorbitol, xylitol, and the like.

The amount of water-activity reducing agent used in a topping can vary, but can preferably be an amount that in combination with the other ingredients of the topping will result in a topping having a freezing point below about 32° F., preferably below 0° F., and is most preferably provided in an amount that will provide one or more of the viscosity, melting point, and fluidity or flowability properties identified above. When glycerin is used, it can preferably be included in a topping in an amount in the range from about 1 to about 15 percent by weight, more preferably from about 4 to about 9 percent by weight.

High Fructose Corn Sweetener

Preferred toppings include high fructose corn sweetener (HFCS) in an amount that in combination with the other ingredients of the topping will cause one or more of a reduction in the freezing point of the topping, a desired viscosity at reduced temperature, and fluidity over a range of reduced temperatures. HFCS is preferably included in an amount sufficient to provide a topping that is fluid enough at temperatures below freezing, e.g., as low as OF or even lower, to allow application of the topping to a food product by dipping the food product in the topping soon after removal of the topping from storage in a refrigerator or freezer. Particularly preferred toppings can have a freezing point below 32° F., preferably below 0° F. Exemplary amounts of HFCS in a topping of the invention can be in the range from about 2 to about 30 weight percent, e.g., from about 5 to about 20 weight percent of the topping composition. High fructose corn sweetener is an ingredient that is well known in the cooking and baking arts, and is commonly and commercially available.

Fat

In preferred embodiments of the topping, one or more of the total fat content and the relative amounts of different types of fat (liquid or solid) can also be controlled to affect the freezing temperature of a topping and facilitate flow at freezing and sub-freezing temperatures.

For instance, the total fat content can preferably be in the range of from about 10% by weight of the topping composition to about 20% by weight of the topping composition, more preferably from about 13% to about 17% by weight of the topping composition. If the total fat content is increased above the upper percentage limit mentioned herein, the product firmness will increase and fluidity may decrease. Conversely, if the total fat content is too low the topping may not exhibit good clinging properties with respect to a food product surface, and in addition, a topping may have a tendency to become too runny at relatively higher temperatures, e.g., nearing room temperature.

The types of fat chosen for use in a topping can depend on the type of topping. Choices include all liquid, all solid, or a mixture of liquid and solid. Preferably, to achieve flowability at reduced temperatures, the ratio of liquid shortening to liquid shortening plus solid (plastic) shortening can be in the range from about 0.26:1 to about 0.43:1. The liquid shortening plus the plastic shortening is the total fat content.

Shortenings useful in food toppings, e.g., icings, are well known. In regard to liquid shortenings, any available liquid shortening can be used, including commercially available liquid shortenings. Preferred liquid shortening or oil ingredients are characterized by being high in mono- or polyunsaturates and generally contain little, if any, emulsifiers. Those most commonly suitable are unsaturated vegetable oils such as cottonseed, oils, soybean oil, coconut oil, rapeseed oil, peanut oil, olive oil, palm oil, palm kernel oils, sunflower seed oil, safflower oil, and the like. The most suitable and preferred is winterized soybean oil.

The plastic or solid shortening or fat, the terms being used interchangeably herein, again can be any of numerous commercially available shortenings. As those skilled in the art know, such shortenings generally are prepared from hydrogenated oils, often with added emulsifiers. Preferred plastic shortenings include those commercially available plastic shortenings generally prepared from hydrogenated oils, often with added emulsifiers. See, e.g., U.S. Pat. No. 4,379,167, incorporated herein by reference.

Flavoring

The topping can and typically does include added flavorings. A flavoring can be chosen depending on the type of topping desired, and can include any one or more of a salt or salt flavoring, a sweetener, a fruit flavor, a vegetable flavor, a dairy flavor, a cheese flavor, a vanilla or chocolate flavor, a hot and/or spicy flavor, and combinations thereof.

It will be appreciated by one of skill that the topping can be tailored for different applications by use of desired flavorings. Specifically, it will be well understood that different flavorings can be added to the other ingredients of the topping (e.g., water, high fructose corn sweetener, fat, and water-activity-reducing agent) to create a topping of a desired flavor for use with a particular food composition. For instance, if a fruit-flavored topping is desired, fruit or fruit flavoring and coloring can be added to the other ingredients. If a cheese flavor is desired, a cheese or cheese flavoring can be included, sugar can be included in an amount in the lower end of the stated range, oil/fat can be included in an amount in the higher end of the range, and other ingredients might include a dairy component and salt. Likewise, if a tomato-flavored topping or tomato sauce is desired, sugar in the lower end of the range might be used, and salt and tomato components (solids) or tomato flavoring and coloring would be added. A syrupy topping might be similar to an icing, but with a flavoring and coloring appropriate for a syrup. A dressing might include added oil, a lower amount of sugar, optionally a dairy component, and selected spices. An icing may include (in addition to the HFCS component of the topping) a sweetener such as a sugar, often powdered sugar.

The amount of flavoring may also have some effect on the freezing and fluid properties of the topping at low temperatures. For example, it has been found that replacement of an amount of powdered sugar with HFCS in icings can suppress the freezing point of an icing.

Sugar Flavoring

Sugar can optionally be included in a topping as a flavoring. The sugar content of an icing can preferably be within the range from about 30% to about 60% by weight, preferably from about 40% to about 58% by weight, and most preferably around 57-58% by weight. A preferred sugar for a sweetener is powdered sugar of a particle size within the range of from about 6× to about 12×, most preferably about 12×.

Because it has been found that the amounts and types of sweetener can have some effect on the freezing point and fluidity of a topping, the amounts and types of sweeteners used in preferred toppings of the invention can be chosen to reduce the freezing point of the topping, to improve fluidity at low temperatures, and preferably to reduce runniness at relatively higher temperatures, e.g., up to room temperature (25° C.). A topping can include some amounts of both a sugar (e.g., powdered sugar) and HFCS, but best effects of depressing freezing point are achieved by substitution of at least some portion of powdered sugar with HFCS. This generally reduces the sweetness of the composition, because HFCS is not as sweet as powdered sugar, but such a substitution is most effective to achieve freezing point suppression. Thus, the amount of sweetener can be balanced to provide desired flavor and sweetness against reduced melting point and increased fluidity properties. A preferred range of powdered sugar used in an icing formulation to achieve properties of reduced melting point, increased fluidity, etc., can be in the range from about 30 to about 60 weight percent.

Water Content

It is preferred to adjust and maintain the overall total water content of a topping to within the range of from about 9% to about 22% by weight and preferably within the range of from about 14% to about 17% by weight.

Exemplary Formulation

Exemplary formulations that can be used to prepare a topping or an icing meeting one or more of the objectives described herein, are summarized as follows:

Icing Formulation

| | Approximate |
|---|---|
| | % By Weight |
| Sugar Content | 30 to 60 |
| Water Content | 9 to 22 |
| Total Fat Content | 10 to 20 |
| Approximate ratio of liquid oil:liquid | 0.26 to 0.43:1 |
| oil plus shortening in Total Fat Content | |
| High Fructose Corn Sweetener | 2 to 30 |
| Water-activity reducing agent | 1 to 15 |

Other ingredients besides those mentioned above may be used in a topping composition, as will be appreciated by a skilled artisan. For example, other typical ingredients may include corn syrup solids, salt, surfactants, coloring, gums, stabilizers, milk products, preservatives, etc. The identity and amounts of these additional ingredients may be varied, as desired, within reasonable use levels, almost at the formulator's will, to an extent that will not have a significant effect on important properties of the topping such as fluidity at sub-freezing temperatures (e.g., as measured by viscosity) and melting temperature. Thus, an important attribute of the final composition is achieved, namely formulation versatility.

The icing or other type of topping can be prepared by combining the described ingredients, as will be understood by one skilled in the food topping art.

### EXAMPLES

Following is an exemplary process for preparing embodiments of the icings according to the invention.

VANILLA ICING FORMULA

| Ingredients | Percentage |
|---|---|
| Powdered Sugar | 44.92 |
| Water | 13.93 |
| Vegetable Shortening | 9.88 |
| Soy Oil | 5.84 |
| Sweet Whey | 4.94 |
| HFCS | 9.91 |
| Glycerine | 5.00 |
| Corn Syrup Solids | 2.44 |
| Dextrose | 2.44 |
| Salt | 0.48 |
| Polysorbate 60 | 0.075 |
| Xanthan Gum | 0.027 |
| Butter/Vanilla Flavor | 0.029 |
| Vanilla Flavor | 0.028 |

CHOCOLATE ICING FORMULA

| Ingredients | Percentage |
|---|---|
| Powdered Sugar | 43.41 |
| Water | 13.46 |
| Vegetable Shortening | 9.55 |
| Soy Oil | 5.64 |
| Sweet Whey | 4.77 |
| HFCS | 9.58 |
| Corn Syrup Solids | 2.36 |
| Dextrose | 2.36 |
| Salt | 0.47 |
| Polysorbate 60 | 0.075 |
| Xanthan Gum | 0.026 |
| Glycerine | 4.83 |
| Butter/Vanilla Flavor | 0.028 |
| Vanilla Flavor | 0.027 |
| Cocoa Powder | 2.41 |
| Cocoa Powder | 0.96 |

| | (Comparative) | Example 3 | Example 4 |
|---|---|---|---|
| Ingredients | (wt%) | (wt%) | (wt%) |
| Pwd Sug | 59.99 | 29.83 | 19.83 |
| Water | 12.27 | 15.58 | 15.48 |
| Short | 9.23 | 10.53 | |
| Oil | 5.45 | 6.23 | 16.75 |
| Whey | 4.61 | 5.26 | 5.26 |
| HFCS | 3.25 | 16.57 | 26.57 |
| Corn Syrup Solids | 2.29 | 2.60 | 2.60 |
| Dextrose | 2.28 | 2.60 | 2.60 |
| Salt | 0.46 | 0.51 | 0.52 |
| Poly 60 | 0.074 | 0.081 | .082 |
| Xanthan Gum | 0.028 | 0.10 | 0.1 |
| Butter/vanilla flavor | 0.028 | 0.031 | 0.031 |
| Vanilla | 0.028 | 0.029 | .029 |
| Glycerine | 0.00 | 10.00 | 10 |

To determine viscosity of the toppings, a Rheometrics Dynamic Stress Rheometer (DSR) (Model- SR-500) was used. A “Plate on Plate” method was used, with a 40 mm diameter plate. The icings were held at a constant stress load over different stress ranges (from 100-1000 Pascal intervals). The temperature used for this test was −17° C. or 0° F.

| | | |
|---|---|---|
| Comparative icing viscosity | K = 325,000,000 cps | n = 0.25 |
| White icing viscosity: | K = 1,637,268 cps | n = 0.30 |
| Chocolate icing viscosity: | K = 2,207,766 cps | n = 0.51 |

K = the viscosity
n = shear dependency

1. A packaged food product comprising, in combination:
a frozen food product; and
a packaged topping composition which if exposed to room temperature for a time taken to warm the frozen food product is sufficiently fluid that the topping composition can be applied to the food product by dipping the food product in the topping composition.

2. The packaged food product of claim 1 wherein the frozen food product comprises a batter product or a dough product.

3. The packaged food product of claim 1 wherein the frozen food product is at least partially cooked.

4. The packaged food product of claim 1 wherein the frozen food product is a frozen dough product or a frozen batter product, and wherein the topping composition is sufficiently fluid at OF that the topping composition can be applied to the dough or batter product by dipping the dough or batter product in the topping composition.

5. The packaged food product of claim 1 wherein the frozen food product is a frozen dough product or a frozen batter product, and wherein the topping composition is sufficiently fluid at 32° F. that the topping composition can be applied to the dough or batter product by dipping the dough or batter product in the topping composition.

6. The packaged food product of claim 1 wherein the time taken to warm the food product is a time in which the food product is warmed to a temperature of at least 50° F.

7. The packaged food product of claim 1 wherein the time taken to warm the dough product is less than about 4 minutes.

8. The packaged food product of claim 1 wherein the topping composition comprises fat, flavoring, water, high-fructose corn sweetener, and water-activity reducing agent.

9. The packaged food product of claim 1 wherein the topping composition comprises
from about 12 to about 20 weight percent fat;
from about 30 to about 60 weight percent flavoring;
from about 9 to about 22 weight percent water; and
high fructose corn sweetener; and
water-activity reducing agent.

10. The packaged food product of claim 9 wherein the flavoring comprises one or more of a sweetener, a fruit flavor, a vegetable flavor, a dairy flavor, a cheese flavor, a spice, a hot flavor, a chocolate flavor, and combinations thereof.

11. The packaged food product of claim 1 wherein the frozen food product is of a size that will fit into a toaster.

12. The packaged food product of claim 1 wherein the food product comprises multiple pieces connected by a line of weakening.

13. The packaged food product of claim 12 wherein the food product comprises a dough product or a batter product comprising two or more elongated sticks connected along their lengths by a line of weakening, and being of a size that can be inserted in a toaster.

14. A method of preparing a food product, the method comprising
providing a packaged food product comprising
a frozen food product; and
a topping composition which if exposed to room temperature for a time taken to warm the frozen food product is sufficiently fluid that the topping composition can be applied to the food product by dipping the food product in the topping composition;
warming the food product; and
applying the topping to the food product.

15. The method of claim 14 wherein the method comprises applying the topping to the food product by dipping the food product in the topping composition.

16. The method of claim 14 wherein the frozen food product comprises a batter product or a dough product.

17. The method of claim 16 wherein the batter or dough product is at least partially cooked.

18. The method of claim 14 wherein the topping composition is sufficiently fluid at OF that the topping composition can be applied to the food product at OF by dipping the food product in the topping composition.

19. The method of claim 14 wherein the topping composition is sufficiently fluid at 32° F. that the topping composition can be applied to the food product at 32° F. by dipping the food product in the topping composition.

20. The method of claim 14 wherein the step of warming the frozen food product comprises warming to a temperature of at least about 50° F.

21. The method of claim 14 wherein the warming step comprises warming the food product in a toaster, a toaster oven, a conventional oven, or a microwave oven.

22. The method of claim 14 wherein the warming step comprises warming the food product in a toaster to a temperature of at least about 50° F.

23. The method of claim 14 wherein the warming step comprises warming the food product in a toaster for a time in the range up to about 5 minutes.

24. A food topping composition comprising fat, flavoring, water, high-fructose corn sweetener, and water-activity reducing agent, the composition being sufficiently fluid at 0° F. that the topping composition can be applied to a food product by dipping the food product in the topping composition.

25. The topping of claim 24 wherein the topping is sufficiently fluid at 32° F. that the topping composition can be applied to a food product by dipping the food product in the topping composition.

26. The topping of claim 24 wherein the flavoring comprises one or more of a sweetener, a fruit flavor, a vegetable flavor, a dairy flavor, a cheese flavor, a spice, a hot flavor, a chocolate flavor, and combinations thereof.

27. The topping of claim 24 wherein the topping composition is an icing and the flavoring is a sweetener.

28. The topping of claim 27 wherein the composition comprises from about 25 to about 45% by weight powdered sugar.

29. The topping of claim 24 wherein the water-activity reducing agent comprises glycerine, sorbitol, mannitol, or a combination thereof.

30. The topping of claim 24 wherein the composition has a melting point in the range from about minus 32 to minus 28° C.

31. The topping of claim 24 wherein the composition has a viscosity in the range from about 500,000 centipoise to about 10,000,000 centipoise at 0° F., as measured using a Rheometrics Model SR-500 Differential Stress Rheometer.

32. The topping of claim 24 comprising:
from about 12 to about 20 weight percent fat;
from about 30 to about 60 weight percent flavoring;
from about 9 to about 22 weight percent water; and
high fructose corn sweetener; and
water-activity reducing agent.

33. The topping of claim 32 wherein the composition comprises up to about 15% by weight water-activity reducing agent.

34. The topping of claim 32 wherein the composition comprises from about 5 to about 70 weight percent high fructose corn sweetener.

35. The topping of claim 32 wherein the composition comprises from about 10 to about 40 weight percent high fructose corn sweetener.

36. The of claim 32 wherein the fat comprises a mixture of liquid oil and hydrogenated shortening, and the ratio of liquid oil to liquid oil plus hydrogenated shortening is in the range from about 0.26:1 to 0.43:1.
